(19) United States
(12) Patent Application Publication
(10) Pub. No.: US 2006/0061553 A1
(43) Pub. Date: Mar. 23, 2006

(54) Double-phase pressing keys for mobile terminals

(76) Inventor: Hannu Korhonen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/946,573

(22) Filed: Sep. 20, 2004

(51) Int. Cl. G09G 5/00

(52) U.S. Cl. 345/168

(57) ABSTRACT

This invention describes a method for a new methodology for double-phase keys used to minimize pressing-key errors in electronic devices (e.g., portable communication devices, mobile phones, etc.). During the first phase, the key is pressed, e.g., half-way without actually sending the information to an active application. When the user presses the key half-way, the operating system of the electronic device provides to the user an audio feedback about the identity of the pressed key. The user can then either move the finger from the key (if it is not an intended key) or press the key all the way down (if it is the intended key). When the key is pressed down fully (the second phase), the appropriate active application actually receives the intended message/command (e.g., a number/character used in the active application) and the electronic device provides to the user an audio feedback confirmation of the fully-pressed key.

### TECHNICAL FIELD

This invention generally relates to electronic devices and more specifically to double-phase pressing keys in these devices for minimizing pressing-key errors.

### BACKGROUND ART

A small keypad physical size and a lack of haptic feedback to a user of an electronic device (e.g., a portable communication device, a mobile phone, etc.) before pressing keys for entering numbers or characters can cause many errors in eyes-busy situations. Currently, if an error occurs, the user has to press a special clear key, which is usually located outside of an area with the number and/or character keys, thus causing the user to lose a location of the key which was just pressed. After pressing the clear key, the user has to search for a correct key once again. However, information about the previously pressed key is lost and cannot help and the user has to rely on a haptic feedback (if that feature is available on the electronic device) or look at a keypad to locate the correct key. It is highly desirable to find a solution where the user does not have to go through the “clearing” procedure as discussed above.

### DISCLOSURE OF THE INVENTION

The object of the present invention is to provide a methodology for double-phase keys used for minimizing pressing-key errors in electronic devices (e.g., portable devices, mobile phones, etc.).

According to a first aspect of the invention, a method for using a double-phase key approach to minimize pressing-key errors in an electronic device, comprises the steps of: pressing half-way one key of N keys of a user interface module of the electronic device by a user of the electronic device with an intent to communicate a predetermined message/command to the electronic device, wherein N is an integer of at least a value of two; providing a half-way feedback signal describing an identity of the one key by the electronic device to the user in response to the half-way pressing; and pressing full-way the one key by the user to communicate the predetermined message/command to the electronic device only if the identity of the one key corresponds to the one key, thus minimizing pressing-key errors by using the double-phase key approach.

According further to the first aspect of the invention, the half-way feedback signal may be a speech feedback signal containing an audio identity of the one key.

According yet further to the first aspect of the invention, after the step of the pressing half-way, the method may comprise the steps of: generating a half-way key actuating signal by the user interface module, optionally using a touch actuator of the user interface module in response to the pressing half-way of the one key; and generating a half-way key signal containing the identity of the one key by an actuation controller of the electronic device in response to the half-way key actuating signal. Still further, the half-way feedback signal may be generated by a half-way feedback block of the electronic device in response to the half-way key signal, and optionally the half-way feedback signal may be a speech feedback signal containing an audio identity of the one key.

Further according to the first aspect of the invention, after the step of the pressing full-way, the method may comprise the steps of: generating a full-way key actuating signal containing the predetermined message/command by a user interface module, optionally using a touch actuator of the user interface module, in response to the pressing full-way of the one key; and generating a full-way key signal by an actuation controller in response to the full-way key actuating signal. Still further, the method may further comprise the steps of: generating by a full-way feedback block a full-way feedback signal, containing a confirmation of communicating the predetermined message/command to the electronic device, in response to the full-way key signal and providing the full-way feedback signal to the user. Yet still further, the full-way feedback signal may be generated by a full-way feedback block of the electronic device, and optionally the full-way feedback signal may be a non-speech feedback signal.

Still further according to the first aspect of the invention, the user interface module may contain a touch-device or a touch-screen, optionally providing a tactile feedback to the user when the one key is pressed full-way.

According further to the first aspect of the invention, the pressing half-way may be implemented as a single click and the pressing full-way may be implemented as a double click or the pressing half-way may be implemented as the double click and the pressing full-way may be implemented as the single click.

According still further to the first aspect of the invention, the pressing half-way may be implemented as a short click and the pressing full-way may be implemented as a long click or the pressing half-way may be implemented as the long click and the pressing full-way may be implemented as the short click.

According further still to the first aspect of the invention, the electronic device may be a wireless device, a portable device, a mobile communication device or a mobile phone.

According to a second aspect of the invention, an electronic device capable of using a double-phase key approach to minimize pressing-key errors, comprises: a user interface module with N keys, responsive to pressing half-way one key of the N keys with an intent to communicate a predetermined message/command to the electronic device by a user of the electronic device and responsive to pressing full-way the one key by the user to communicate the predetermined message/command to the electronic device, wherein N is an integer of at least a value of two; and means for providing a half-way feedback signal describing an identity of the one key by the electronic device in response to the half-way pressing to the user, wherein the pressing full-way the one key by the user occurs only if the identity of the one key corresponds to the one key, thus minimizing pressing-key errors by using the double-phase key approach.

According further to the second aspect of the invention, the half-way feedback signal may be a speech feedback signal containing an audio identity of the one key.

According yet further to the second aspect of the invention, in response to the pressing half-way the one key, the user interface module may generate a half-way key actuating signal and in response to the pressing full-way the one, key the user interface module may generate a full-way key actuating signal, optionally using a touch actuator of the user interface module for generating both the half-way key actuating signal and the full-way key actuating signal. Still further, the electronic device may further comprise: an actuation controller, responsive to the half-way key actuating signal and to the full-way key actuating signal, for providing a half-way key signal containing the identity of the one key in response to the half-way key actuating signal and for providing a full-way key signal containing the predetermined message/command. Yet still further, the means for providing a half-way feedback signal may be a half-way feedback block, which provides the half-way feedback signal in response to the half-way key signal, and optionally the half-way feedback signal may be a speech feedback signal containing an audio identity of the one key. Further still, the electronic device may further comprise: a full-way feedback block, responsive to the full-way key signal, for providing to the user a full-way feedback signal containing a confirmation of communicating the predetermined message/command to the electronic device. Still yet further, the full-way feedback signal may be a non-speech feedback signal. Yet further still, the half-way feedback block and the full-way feedback block may be combined.

Further according to the second aspect of the invention, the user interface module may contain a touch-device or a touch-screen, optionally providing a tactile feedback to the user when the one key is pressed full-way.

Still further according to the second aspect of the invention, the electronic device may be a wireless device, a portable device, a mobile communication device or a mobile phone.

According further to the second aspect of the invention, the pressing half-way may be implemented as a single click and the pressing full-way may be implemented as a double click or the pressing half-way may be implemented as the double click and the pressing full-way may be implemented as the single click.

According still further to the second aspect of the invention, the pressing half-way may be implemented as a short click and the pressing fill-way may be implemented as a long click or the pressing half-way may be implemented as the long click and the pressing full-way may be implemented as the short click.

According to a third aspect of the invention, a computer program product comprises: a computer readable storage structure embodying computer program code thereon for execution by a computer processor with the computer program code characterized in that it includes instructions for performing the steps of the first aspect of the invention indicated as being performed by any component or a combination of components of the electronic device.

According to a fourth aspect of the invention, a method for using a double-state key approach using half-way and full-way key pressing to maximize input options in a mobile communication terminal, comprises the step of: pressing half-way one key of N keys of a user interface module of said mobile communication terminal by a user of said mobile communication terminal to provide a first message/command to said mobile communication terminal, or pressing full-way said one key by said user to provide a second message/command to said mobile communication terminal, or pressing said one key sequentially half-way and then full-way by said user to provide said first message/command and then said second message/command to said mobile communication terminal, or pressing said one key sequentially full-way and then half-way by said user to provide said second message/command and then said first message/command to said mobile communication terminal, thus maximizing said input options in said mobile communication terminal, wherein N is an integer of at least a value of one.

According to a fifth aspect of the invention, a method for using a multi-state-pressing key of a user interface of mobile communication terminal having K multiple operative positions to maximize input options in a mobile communication terminal, comprising the step of: pressing said multi-state-pressing key by a user of said mobile communication terminal to any operating position of said K multi-operating positions to provide a corresponding message/command to said mobile communication terminal, thus maximizing said input options in said mobile communication terminal, wherein each pressing position of said multi-state-pressing key corresponds to one operating position of said K multi-operating positions and provides one unique message/command to said mobile communication terminal and K is an integer of at least a value of two.

The main advantage of the present invention is that a number of incorrect key presses will dramatically drop since the user can confirm each key press before actually pressing the key to implement the desired message/command. This is especially important in eye-busy situations because the user may not be able to see a screen at that moment. This invention will also benefit disabled users who have low vision or motor difficulties controlling their hands so they can make sure that there are no numbers or text entry errors.

### BRIEF DESCRIPTION OF THE DRAWINGS

For a better understanding of the nature and objects of the present invention, reference is made to the following detailed description taken in conjunction with the following drawings, in which:

FIG. 1 is a block diagram of an electronic device capable of using a double-phase key approach to minimize pressing-key errors, according to the present invention; and

FIG. 2 is a flow chart demonstrating a double-phase key approach to minimize pressing-key errors in an electronic device, according to the present invention.

### BEST MODE FOR CARRYING OUT THE INVENTION

The present invention provides a new methodology for double-phase keys used for minimizing pressing-key errors in electronic devices (e.g., portable communication devices, mobile phones, etc.).

According to the present invention, each key (or each button) on a keypad of the electronic device has two phases. The user can press the button, e.g., only half-way down and get a feedback about a button identity. Pressing the key all the way down will actually enter a number/character to an active application for communicating a certain message/command to the electronic device. According to the present invention, a preferred feedback method is an audio signal and more specifically a speech signal since in eye-busy situations the user may not be able to look at the screen.

Thus, during the first phase, the key is pressed, e.g., half-way without actually sending the information to the active application. When the user presses the key half-way down, the operating system of the electronic device provides to the user an audio feedback about the identity of the pressed key. The user can then either move the finger from the key (if it is not an intended key) or press the key all the way down (if it is the intended key). When the key is pressed down fully (the second phase), the appropriate active application actually receives the indented message/command (e.g., a number/character used in the application). The operating system recognizes this event and provides an acknowledgement (feedback) signal to the user (again an audio signal can be used, but other feedback types including a tactile feedback are also feasible). For example, when the user enters a number for the, active application, the user can receive an audio feedback indicating the number of the pressed key. Correspondingly, if the active application expects a text entry, the audio feedback includes characters that are attached to the key.

Speech is a convenient way for providing the feedback about the identity of the pressed key. The audio feedback can be a descriptive one like “Number five”, “Contains characters g, h and i” or something similar. When the key is pressed, the non-speech audio feedback is enough because the user already knows what the key is.

With two-phase buttons (keys) the user can get the feedback regarding the key he/she is going to press and therefore, changing to a different key is easier because the user knows the current location of his/her thumb (or other finger) on the keypad.

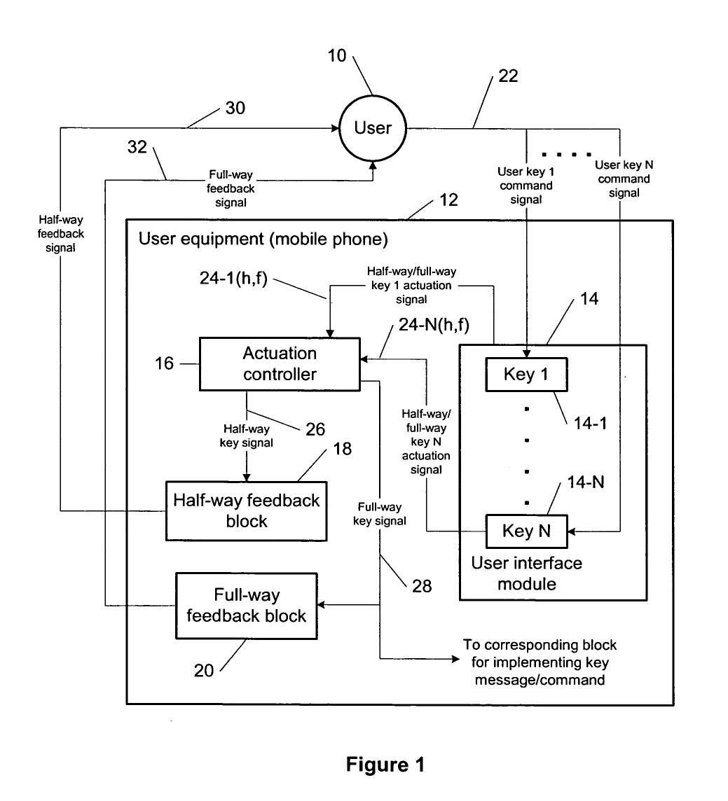

FIG. 1 shows one example among others of a block diagram of an electronic device 12 capable of using a double-phase key approach to minimize pressing-key errors, according to the present invention. The electronic device can be, e.g., a wireless device, a portable device, a mobile communication device, a mobile phone, etc.

A user 10 sends a user command signal 22 by pressing half-way or full-way one key (e.g., key #1) of N keys 14-1, 14-2, . . . and 14-N of a user interface module 14 of the electronic device 12 with an intent to communicate or for communicating a predetermined message/command to said electronic device 10, respectively, wherein N is an integer of at least a value of one. The user interface module 14 can be implemented in a variety of ways. For example, the user interface module 14 can contain a touch-device such as a touch-screen with a keypad. In response to the user command signal 22, the user interface module 14 provides a half-way key actuating signal 24-1h, 24-2h, . . . or 24-Nh or a full-way key actuating signal 24-1f, 24-2f, . . . or 24-Nf to an actuation controller 16.

As mentioned above, during the first phase the user presses the one key of said N keys 14-1, 14-2, . . . and 14-N only half-way which results in providing the half-way key actuating signal 24-1h, 24-2h, . . . or 24-Nh to the actuation controller 16. In response to the half-way key actuating signal 24-1h, 24-2h, . . . or 24-Nh, the actuation controller 16 generates a half-way key signal 26 containing the identity of the one key pressed half-way. The half-way key signal 26 is provided to a half-way feedback block 18. The half-way feedback block 18 generates and provides to the user 10 a half-way feedback signal 30 describing an identity of said one key in response to said half-way key signal 26. As mentioned above, in a preferred embodiment of the present invention, said half-way feedback signal 30 is an audio signal, e.g., a speech feedback signal containing an audio identity of said one key.

If the user 10 determines that the half-way pressed key is an intended key (corresponding to the predetermined message/command), then the user 10 presses said one key full-way. If, however, the user 10 determines that the half-way pressed key is not the intended key, the user 10 can move the finger from that one key and press (again only half-way) the right key, thus minimizing pressing-key errors by using the double-phase key approach of the present invention.

Thus, during the second phase the user presses the one key of said N keys 14-1, 14-2, . . . and 14-N full-way resulting in providing the full-way key actuating signal 24-1f, 24-2f, . . . or 24-Nf to the actuation controller 16. In response to the full-way key actuating signal 24-1f, 24-2f, . . . or 24-Nf, the actuation controller 16 generates a a full-way key signal 28 containing the predetermined message/command. The full-way key signal 28 is sent to a corresponding block (application) of the electronic device 12 for implementing the message/command and also provided to a full-way feedback block 20. The full-way feedback block 20 generates and provides to the user 10 a full-way feedback signal 32 containing a confirmation of communicating said predetermined message/command to said electronic device 12 in response to the full-way key signal 28. The full-way feedback signal 32 can be an audio signal, but not necessarily a speech feedback signal. The full-way feedback signal 32 can be, for example, a tactile feedback signal.

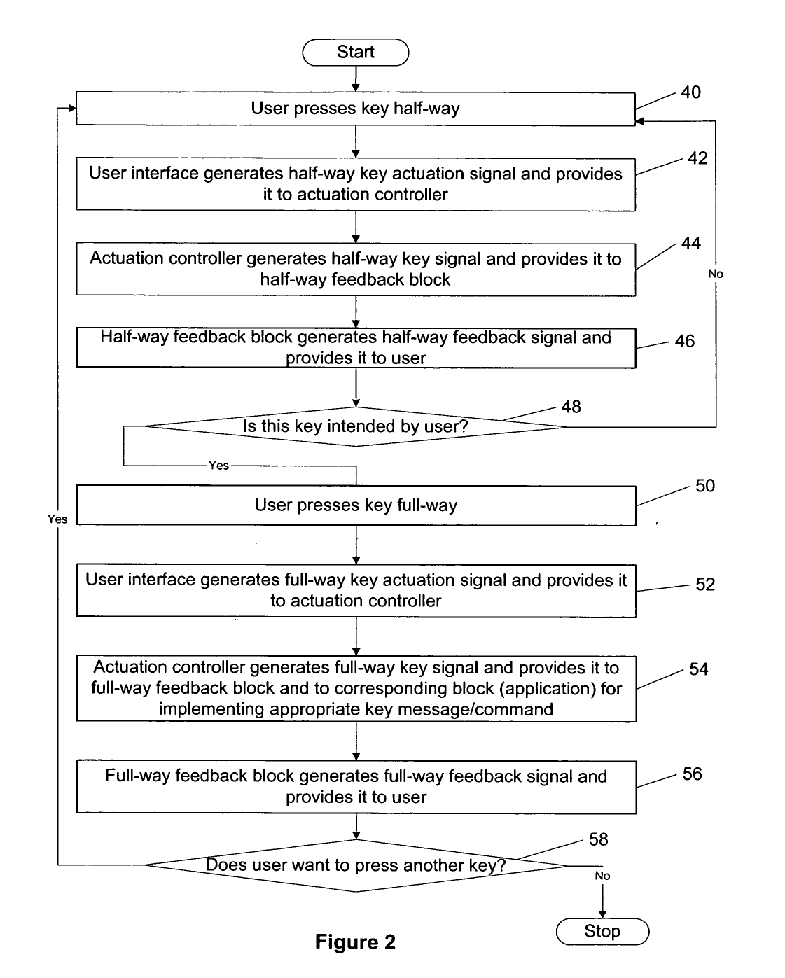

FIG. 2 shows a flow chart demonstrating a double-phase key approach for minimizing pressing-key errors in an electronic device, according to the present invention.

The flow chart of FIG. 2 only represents one possible scenario among many others. In a method according to the present invention, in a first step 40, the user 10 presses an appropriate key (e.g., providing the user command signal 22 to the key #1 of the N keys 14-1, 14-2, . . . and 14-N of the user interface module 14) only half-way with an intent to communicate the predetermined message/command to said electronic device 10. In a next step 42, the user interface module 14 generates and provides to the actuation controller 16 the half-way key actuating signal 24-1, 24-2, . . . or 24-N in response to the user command signal 22.

In a next step 44, the actuation controller 16 generates and provides to the half-way feedback block 18 a half-way key signal 26 containing the identity of the one key pressed half-way in response to the half-way key actuating signal 24-1h, 24-2h, . . . or 24-Nh. In a next step 44, the half-way feedback block 18 generates and provides to the user 10 a half-way feedback signal 30 describing the identity of said one key in response to the half-way key signal 26

In a next step 48, it is determined whether the half-way pressed key is an intended key (corresponding to the predetermined message/command). If that is not the case, the process goes back to step 42, e.g., the user 10 moves the finger from that one key and presses, again only half-way, the right (appropriate) key. If, however, the user 10 determines that the half-way pressed key is the intended key, in a next step 50, the user 10 presses that key full-way to communicate a predetermined message/command to said electronic device 10 (e.g., to an appropriate application).

In a next step 52, the user interface module 14 generates and provides to the actuation controller 16 the full-way key actuating signal 24-1f, 24-2f, . . . or 24-Nf. In a next step 54, the actuation controller 16 generates the full-way key signal 28 containing the predetermined message/command in response to the full-way key actuating signal 24-1f, 24-2f, . . . or 24-Nf, and the full-way key signal 28 is sent to a corresponding block (application) of the electronic device 12 for implementing the message/command and also provided to a full-way feedback block 20.

In a next step 56, the full-way feedback block 20 generates and provides to the user 10 a full-way feedback signal 32 containing a confirmation of communicating said predetermined message/command to said electronic device 10 in response to the full-way key signal 28.

Finally, in a next step 58, it is determined whether the user 10 wants to press another key (i.e., to send another message/command to the appropriate application). If that is not the case, the process stops. If, however, the user 10 wants to press another key, the process goes back to step 42.

According to the present invention, there are a variety of ways to facilitate two phases, i.e., pressing “half-way” and “full-way”. For example, using a touch-screen technology, the distinction between “half-way” and “full-way” can be implemented by increasing a contact area (and detecting this increase) of an actuator with the touch-screen when the key is pressed full-way versus only half-way. This “contact area” approach can be also applied, if necessary, to more than two key pressing operating positions, e.g., third-way, two-third-way and full-way.

Furthermore, according to the present invention, the terms “half-way” and “full-way” have a broader interpretation. For example, pressing “half-way” can be a single click and pressing “full-way” can be a double click or visa versa. In an alternative implementation, the pressing “half-way” can be a short click and pressing “full-way” can be a long click or visa versa.

1. A method for using a double-phase key approach to minimize pressing-key errors in an electronic device, comprising the steps of:
pressing half-way one key of N keys of a user interface module of said electronic device by a user of said electronic device with an intent to communicate a predetermined message/command to said electronic device, wherein N is an integer of at least a value of two;
providing a half-way feedback signal describing an identity of said one key by said electronic device to the user in response to said half-way pressing; and
pressing full-way said one key by the user to communicate said predetermined message/command to said electronic device only if said identity of said one key corresponds to said one key, thus minimizing pressing-key errors by using said double-phase key approach.

2. The method of claim 1, wherein said half-way feedback signal is a speech feedback signal containing an audio identity of said one key.

3. The method of claim 1, wherein after the step of said pressing half-way, the method comprises the steps of:
generating a half-way key actuating signal by said user interface module, optionally using a touch actuator of said user interface module in response to said pressing half-way of said one key; and
generating a half-way key signal containing said identity of said one key by an actuation controller of said electronic device in response to said half-way key actuating signal.

4. The method of claim 3, wherein said half-way feedback signal is generated by a half-way feedback block of said electronic device in response to said half-way key signal, and optionally said half-way feedback signal is a speech feedback signal containing an audio identity of said one key.

5. The method of claim 1, wherein after the step of said pressing full-way, the method comprises the steps of:
generating a full-way key actuating signal containing said predetermined message/command by a user interface module, optionally using a touch actuator of said user interface module, in response to said pressing full-way of said one key; and
generating a full-way key signal by an actuation controller in response to said full-way key actuating signal.

6. The method of claim 5, further comprises the steps of:
generating, by a full-way feedback block of the electronic device, a full-way feedback signal, containing a confirmation of communicating said predetermined message/command to said electronic device, in response to said full-way key signal and providing said full-way feedback signal to the user.

7. The method of claim 6, wherein said full-way feedback signal.

8. The method of claim 1, wherein said user interface module contains a touch-device or a touch-screen, optionally providing a tactile feedback to the user when said one key is pressed full-way.

9. The method of claim 1, wherein said pressing half-way is implemented as a single click and said pressing full-way is implemented as a double click or said pressing half-way is implemented as the double click and said pressing full-way is implemented as the single click.

10. The method of claim 1, wherein said pressing half-way is implemented as a short click and said pressing full-way is implemented as a long click or said pressing half-way is implemented as the long click and said pressing full-way is implemented as the short click.

11. The method of claim 1, wherein said electronic device is a wireless device, a portable device, a mobile communication device or a mobile phone.

12. A computer program product comprising: a computer readable storage structure embodying computer program code thereon for execution by a computer processor with said computer program code characterized in that it includes instructions for performing the steps of the method of claim 1 indicated as being performed by any component or a combination of components of said electronic device.

13. An electronic device capable of using a double-phase key approach to minimize pressing-key errors, comprising:
a user interface module with N keys, responsive to pressing half-way one key of said N keys with an intent to communicate a predetermined message/command to said electronic device by a user of said electronic device and responsive to pressing full-way said one key by said user to communicate said predetermined message/command to said electronic device, wherein N is an integer of at least a value of two; and
means for providing a half-way feedback signal describing an identity of said one key by said electronic device in response to said half-way pressing to the user,
wherein said pressing full-way said one key by the user occurs only if said identity of said one key corresponds to said one key, thus minimizing pressing-key errors by using said double-phase key approach.

14. The electronic device of claim 13, wherein said half-way feedback signal is a speech feedback signal containing an audio identity of said one key.

15. The electronic device of claim 13, wherein in response to said pressing half-way said one key, said user interface module generates a half-way key actuating signal and in response to said pressing full-way said one key, said user interface module generates a full-way key actuating signal, optionally using a touch actuator of said user interface module for generating both the half-way key actuating signal and the full-way key actuating signal.

16. The electronic device of claim 15, wherein said electronic device further comprises:
an actuation controller, responsive to said half-way key actuating signal and to said full-way key actuating signal, for providing a half-way key signal containing said identity of said one key in response to said half-way key actuating signal and for providing a full-way key signal containing said predetermined message/command.

17. The electronic device of claim 16, wherein said means for providing a half-way feedback signal is a half-way feedback block, which provides said half-way feedback signal in response to said half-way key signal, and optionally said half-way feedback signal is a speech feedback signal containing an audio identity of said one key.

18. The electronic device of claim 17, wherein said electronic device further comprises:
a full-way feedback block, responsive to said full-way key signal, for providing to the user a full-way feedback signal containing a confirmation of communicating said predetermined message/command to said electronic device.

19. The electronic device of claim 18, wherein said full-way feedback signal is a non-speech feedback signal.

20. The electronic device of claim 18, wherein said half-way feedback block and said full-way feedback block are combined.

21. The electronic device of claim 13, wherein said user interface module contains a touch-device or a touch-screen, optionally providing a tactile feedback to the user when said one key is pressed full-way.

22. The electronic device of claim 13, wherein said electronic device is a wireless device, a portable device, a mobile communication device or a mobile phone.

23. The electronic device of claim 13, wherein said pressing half-way is implemented as a single click and said pressing full-way is implemented as a double click or said pressing half-way is implemented as the double click and said pressing full-way is implemented as the single click.

24. The electronic device of claim 13, wherein said pressing half-way is implemented as a short click and said pressing full-way is implemented as a long click or said pressing half-way is implemented as the long click and said pressing full-way is implemented as the short click.

25. A method for using a double-state key approach using half-way and full-way key pressing to maximize input options in a mobile communication terminal, comprising the step of:
pressing half-way one key of N keys of a user interface module of said mobile communication terminal by a user of said mobile communication terminal to provide a first message/command to said mobile communication terminal, or pressing full-way said one key by said user to provide a second message/command to said mobile communication terminal, or pressing said one key sequentially half-way and then full-way by said user to provide said first message/command and then said second message/command to said mobile communication terminal, or pressing said one key sequentially full-way and then half-way by said user to provide said second message/command and then said first message/command to said mobile communication terminal, thus maximizing said input options in said mobile communication terminal, wherein N is an integer of at least a value of one.

26. A method for using a multi-state-pressing key of a user interface of mobile communication terminal having K multiple operative positions to maximize input options in a mobile communication terminal, comprising the step of:
pressing said multi-state-pressing key by a user of said mobile communication terminal to any operating position of said K multi-operating positions to provide a corresponding message/command to said mobile communication terminal, thus maximizing said input options in said mobile communication terminal, wherein each pressing position of said multi-state-pressing key corresponds to one operating position of said K multi-operating positions and provides one unique message/command to said mobile communication terminal and K is an integer of at least a value of two.
